(19) United States
(12) Patent Application Publication
(10) Pub. No.: US 2011/0289806 A1
(43) Pub. Date: Dec. 1, 2011

(54) Brightening Rectangular Hollow Frame For License Plate

(76) Inventor: Stanley Kuo, Taipei (TW)

(21) Appl. No.: 12/786,927

(22) Filed: May 25, 2010

(51) Int. Cl. B60R 13/10

(52) U.S. Cl. 40/204

(57) ABSTRACT

The present invention discloses a brightening rectangular hollow frame for license plat. The brightening rectangular hollow frame for license plat at least comprises a rectangular hollow frame, and a plurality of light-emitting elements. The mentioned rectangular hollow frame and light-emitting elements can be used to adorn a license plate, and the containing of the license plate will not be covered by the brightening rectangular hollow frame for license plate according to this specification at all.

### BACKGROUND OF THE INVENTION

1. Field of the Invention

The present invention is generally related to a frame for license plate, and more particularly to a brightening rectangular hollow frame for license plate.

2. Description of the Prior Art

As the identification card to human being, a license plate is the legal identification of a vehicle. On a license plate, there is generally a mark combination of several letters and numbers, so that every license plate is almost uniform excluding the containing mark thereon. In order to show some difference from others, many kinds of decoration for license plate are created.

For example, some brightening/light reflection/fluorescence or symbolic decorations are employed onto the frame of the license plate or the words of the license plate. However, the mentioned recent decorations will easily cause the license plate becoming un-identified. For preventing the above-mentioned situation happened with crimes, it is regularized by many countries that using any decoration covering the containing of the license plate is illegal.

Accordingly, it is important to provide a license plate decoration wherein the license plate decoration is particular and not illegal.

### SUMMARY OF THE INVENTION

In view of the above background and to fulfill the industrial requirements, a new brightening rectangular hollow frame for license plate is disclosed in this specification.

It is one object of the invention to provide a brightening rectangular hollow frame for license plate to be not illegal by not covering the containing of a license plate while using.

It is another object of the invention to provide a brightening rectangular hollow frame for license plate to adorn a license plate with imitative metal gloss frame through employing a license plate frame made of imitative metal gloss material.

It is still another object of the invention to provide a brightening rectangular hollow frame for license plate to adorn a license plate with brightening frame through employing a license plate frame made of transparent or semi-opaque material, and light-emitting element(s).

According to these objectives, this present specification discloses a brightening rectangular hollow frame for license plate. The mentioned brightening rectangular hollow frame for license plate comprises a rectangular hollow frame, and light-emitting elements. The light-emitting elements are positioned in the rectangular hollow frame, and the rectangular hollow frame can be made of transparent or semi-opaque materials. While assembling the brightening rectangular hollow frame for license plate onto a license plate, the containing of the license plate will not be covered at all.

### BRIEF DESCRIPTION OF THE DRAWINGS

The present disclosure can be described by the embodiments given below. It is understood, however, that the embodiments below are not necessarily limitations to the present disclosure, but are used to a typical implementation of the invention.

FIG. 1A illustrates a brightening rectangular hollow frame for license plate according to this application;

FIG. 1B is a rearview of a brightening rectangular hollow frame for license plate according to this application; and

FIG. 2 shows a license plate assembled with a brightening rectangular hollow frame for license plate according to this application.

### DESCRIPTION OF THE PREFERRED EMBODIMENTS

What probed into the invention is a brightening rectangular hollow frame for license plate. Detailed descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

One preferred embodiment according to this specification discloses a brightening rectangular hollow frame for license plate. The license plate belongs to a vehicle, wherein the vehicle comprises car, motorcycle, and bike. The mentioned brightening rectangular hollow frame for license plate comprises a rectangular hollow frame, and a plurality of light-emitting elements. The size of the rectangular hollow frame can be a little larger than a license plate, so that when assembling the brightening rectangular hollow frame for license plate onto the license plate, the containing of the license plate will not be covered by the rectangular hollow frame at all.

The rectangular hollow frame comprises at least a fastening part, and each fastening part comprises a fixing hole. In one preferred example of this embodiment, the fastening part is extended from the rectangular hollow frame. In another preferred example according to this embodiment, the mentioned fastening part is fixed onto the rectangular hollow frame. With fixing element(s) through the fixing hole(s), the brightening rectangular hollow frame for license plate can be assembled at the outside of a license plate. Preferably, because the size of the rectangular hollow frame is larger than the license plate, the containing of the license plate will not be covered by the brightening rectangular hollow frame for license plate at all.

The rectangular hollow frame can be made of transparent or semi-opaque material. In one preferred example of this embodiment, the rectangular hollow frame can be made of semi-opaque material, and the semi-opaque material is with imitative metal gloss.

The light-emitting elements are positioned into the rectangular hollow frame. Because the rectangular hollow frame is transparent or semi-opaque, the light from the light-emitting elements will pass or partially pass the rectangular hollow frame to adorn the license plate. In one preferred example of this embodiment, the light-emitting elements are positioned into one side of the rectangular hollow frame. In another preferred example of this embodiment, the light-emitting elements are positioned into more than one side of the rectangular hollow frame.

In one preferred example of this embodiment, the rectangular hollow frame can further comprise a plurality of placing holes. The mentioned placing holes can be positioned at the concave in the rear of the rectangular hollow frame. According to this example, the light-emitting elements can be respectively positioned into the mentioned placing holes.

The light-emitting elements can be electronic coupled with the electronic system of the vehicle. In one preferred example of this embodiment, the light-emitting elements are electronic coupled with a night-light of a vehicle. So that when the night light of the vehicle is turned on, the light-emitting elements of the brightening rectangular hollow frame for license plate will also be turned on. In another preferred example of this embodiment, the light-emitting elements are electronic coupled with a brake light of a vehicle. So that when the brake of the vehicle is triggered, the light-emitting elements of the brightening rectangular hollow frame for license plate and the brake light(s) of the vehicle will both be turned on. In still another preferred example of this embodiment, the mentioned light-emitting elements are also electronic coupled with an independent electric circuit with a switch, so that the light-emitting elements also can be controlled independently through the switch.

In one preferred example according to this embodiment, the brightening rectangular hollow frame for license plat can further comprise an insulating layer. And, the light-emitting elements are positioned between the insulating layer and the rectangular hollow frame. The insulating layer can be employed for keeping the light-emitting elements from electronic leakage.

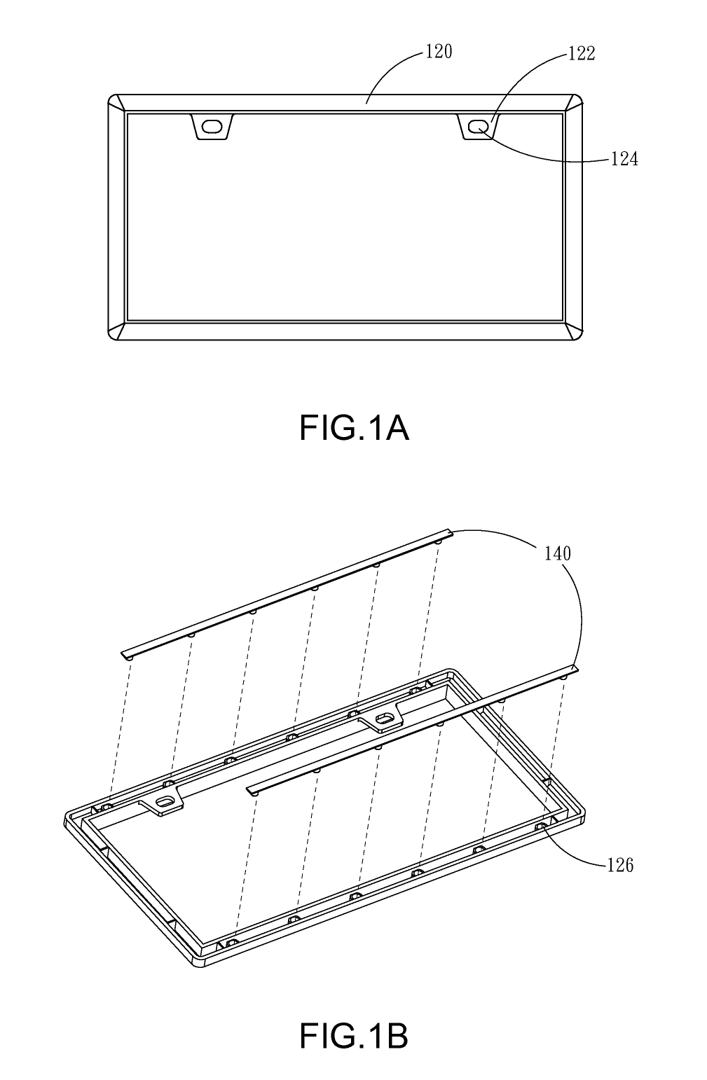

Another preferred embodiment according to this specification discloses a brightening rectangular hollow frame for license plate 100, as shown in FIG. 1A and FIG. 1B. The mentioned brightening rectangular hollow frame for license plate 100 comprises a rectangular hollow frame 120, and a plurality of light-emitting elements 140. The rectangular hollow frame 120 can be made of transparent or semi-opaque material. In one preferred example of this embodiment, the rectangular hollow frame 120 can be made of semi-opaque material, and the semi-opaque material is with imitative metal gloss.

The rectangular hollow frame 120 comprises at least a fastening part 122, and each fastening part 122 comprises a fixing hole 124. In one preferred example of this embodiment, the fastening part 122 is extended from the rectangular hollow frame 120. In another preferred example according to this embodiment, the mentioned fastening part 122 is fixed onto the rectangular hollow frame 120 through any known method of the one skilled in that art. With fixing element(s) through the fixing hole(s) 124, the brightening rectangular hollow frame for license plate 100 can be assembled at the outside of a license plate. Preferably, because the size of the rectangular hollow frame 120 is larger than the license plate, the containing of the license plate will not be covered by the brightening rectangular hollow frame for license plate 100 at all.

The light-emitting elements 140 can be positioned into the rectangular hollow frame 120. The light from the light-emitting elements 140 will pass or partially pass the rectangular hollow frame 120 to adorn the license plate. The light-emitting elements 140 are positioned into at least one side of the rectangular hollow frame 120. In one preferred example of this embodiment, referred to FIG. 1B, the light-emitting elements 140 are positioned into the upper side and the lower side of the rectangular hollow frame 120.

According to one preferred example of this embodiment, referred to FIG. 1B, the rectangular hollow frame 120 can further comprise a plurality of placing holes 126. The mentioned placing holes 126 can be in the concave of the rectangular hollow frame 120. According to this example, the light-emitting elements 140 can be respectively positioned into the mentioned placing holes 126.

According to this embodiment, the light-emitting elements 140 can be selected from light bulb, LED, OLED, inert gas bulb, or other light-emitting elements known by the one skilled in that art. The color of the light-emitting elements 140 can be any commercial available color and can be alternated.

The light-emitting elements 140 can be electronic coupled with the electronic system of the vehicle. In one preferred example of this embodiment, the light-emitting elements 140 are electronic coupled with a nightlight of a vehicle. So that when the night light of the vehicle is turned on, the light-emitting elements 140 of the brightening rectangular hollow frame for license plate 100 will also be turned on. In another preferred example of this embodiment, the light-emitting elements 140 are electronic coupled with a brake light of a vehicle. So that when the brake of the vehicle is triggered, the light-emitting elements 140 of the brightening rectangular hollow frame for license plate 100 and the brake light(s) of the vehicle will both be turned on. In still another preferred example of this embodiment, the mentioned light-emitting elements 140 are also electronic coupled with an independent electric circuit with a switch, so that the light-emitting elements 140 also can be controlled independently through the switch.

In one preferred example according to this embodiment, the brightening rectangular hollow frame for license plat 100 can further comprise an insulating layer, not shown in the figures. According to this example, the light-emitting elements 140 are positioned between the insulating layer and the rectangular hollow frame 120. The insulating layer can be employed for keeping the light-emitting elements 140 from electronic leakage.

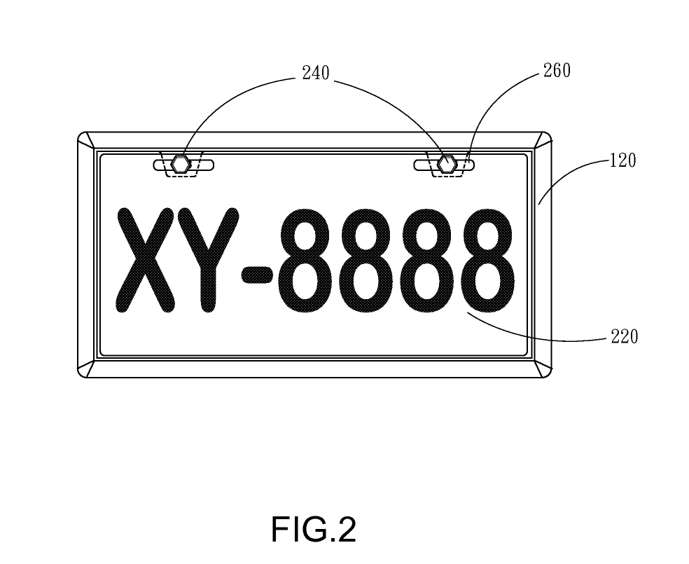

In order to further illustrating the design of this specification, FIG. 2 shows the combination of a license plate and a brightening rectangular hollow frame for license plate according to this specification. FIG. 2 can be a preferred example for illustrating the above embodiments. However, the scope of this specification should not be limited with FIG. 2.

Referred to FIG. 2, with fixing elements 240 passing through the fastening holes 260 of a license plate 220 and the fixing holes of the rectangular hollow frame 120, the brightening rectangular hollow frame for license plate 100 can be assembled onto the license plate 200 on a vehicle. The rectangular hollow frame 120 can be made from semi-opaque material with imitative metal gloss. When the light-emitting elements 140 are not working, the rectangular hollow frame 120 can present imitative metal gloss to adorn the license plate. When the light-emitting elements 140 are working, the rectangular hollow frame 120 can provide different visual impression to adorn the license plate. For example, if the light-emitting elements 140 in FIG. 2 positioned as FIG. 1B, when the light-emitting elements 140 are turn on, light from the light-emitting elements 140 will pass or partially pass across the upper and the lower sides of the rectangular hollow frame 120 to adorn the license plate 220.

Synthetically, this specification discloses a brightening rectangular hollow frame for license plate. The brightening rectangular hollow frame for license plate comprises a rectangular hollow frame, and a plurality of light-emitting elements. When the rectangular hollow frame is not only semi-opaque but also with imitative metal gloss, the brightening rectangular hollow frame for license plate can provide different visual impression to adorn the license plate while the light-emitting elements are working or not.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A brightening rectangular hollow frame for license plate, comprising:
a rectangular hollow frame, wherein the rectangular hollow frame is semi-opaque and with imitative metal gloss;
two fastening parts on the rectangular hollow frame, wherein each of the fastening parts comprises a fixing hole and the rectangular hollow frame is assembled onto a license plate through two fixing elements passing across the fixing holes and two fastening holes of the license plate; and
a plurality of light-emitting elements, wherein the light-emitting elements are positioned in the rectangular hollow frame.

2. The brightening rectangular hollow frame for license plate according to claim 1, wherein the size of said rectangular hollow frame is larger than the license plate.

3. The brightening rectangular hollow frame for license plate according to claim 1, wherein the light-emitting elements are positioned into at least one side of the rectangular hollow frame.

4. The brightening rectangular hollow frame for license plate according to claim 1, further comprising a plurality of placing holes, the placing holes are positioned into at least one side of the rectangular hollow frame.

5. The brightening rectangular hollow frame for license plate according to claim 4, wherein the light-emitting elements are respectively positioned into the placing holes.

6. The brightening rectangular hollow frame for license plate according to claim 1, wherein the rectangular hollow frame comprises four round angles.

7. The brightening rectangular hollow frame for license plate according to claim 1, wherein the light-emitting elements are electronic coupled with night light of a vehicle.

8. The brightening rectangular hollow frame for license plate according to claim 1, wherein the light-emitting elements are electronic coupled with brake light of a vehicle.

9. The brightening rectangular hollow frame for license plate according to claim 1, wherein the light-emitting elements are electronic coupled with an independent switch positioned on a vehicle.

10. The brightening rectangular hollow frame for license plate according to claim 1, further comprising an insulating layer, wherein the light-emitting elements are positioned between the rectangular hollow frame and the insulating layer.
